(19) United States
(12) Patent Application Publication
(10) Pub. No.: US 2014/0346272 A1
(43) Pub. Date: Nov. 27, 2014

(54) AIRCRAFT LANDING GEAR STRUT

(71) Applicant: Renesas Electronics Corporation, Kawasaki-shi, Kanagawa (JP)

(72) Inventor: Pascal Hitier, Velizy Villacoublay (FR)

(73) Assignee: Renesas Electronics Corporation, Kawasaki-shi, Kanagawa (JP)

(21) Appl. No.: 14/363,188

(22) PCT Filed: Dec. 6, 2012
(86) PCT No.: PCT/EP2012/074712

§ 371 Date: Jun. 5, 2014

(30) Foreign Application Priority Data
Dec. 7, 2011 (FR) 1161292

(51) Int. Cl. B64C 25/02

(52) U.S. Cl. CPC B64C 25/02; B23K 2201/00
USPC 244/100 R; 228/101

(57) ABSTRACT

A landing gear rod (1) for an aircraft, the rod comprising a tubular portion (3) for receiving a shock absorber and an axle-carrier portion (2) situated at the end of the tubular portion (3) and adapted to receive a landing gear wheel support mechanism. The tubular portion (3) and the axle-carrier portion (2) are made of mutually distinct metal materials, the tubular portion (3) being made of a first metal material and the axle-carrier portion (2) being made of a second metal material, the tubular portion (3) and the axle-carrier portion (2) being connected together by at least one weld (4).

### BACKGROUND OF THE INVENTION

In general, aircraft landing gear includes a strut connected to the aircraft and receiving a shock absorber. The landing gear also has a landing gear rod designed to penetrate in part inside the strut and to slide therein. The rod is connected firstly to the shock absorber and secondly to an axle-carrier mechanism on which the wheels for enabling the aircraft to run on the ground are mounted.

The rod therefore has a mechanical connection function between the wheels and the aircraft in order to enable the aircraft to run on the ground. The landing gear rod is consequently a mechanical member that is particularly highly stressed during landing since it must withstand the impact of landing, it must carry the aircraft while it is running on the ground, and it must transmit the forces for braking the wheels on the ground in order to enable the aircraft to stop. Consequently, the landing gear rod needs to accept compression forces along the axis of the rod and also bending forces, e.g. during braking.

In order to withstand such forces, landing gear rods are generally made by forging a solid part that is T-shaped or Y-shaped. Forging serves to improve the mechanical strength of the rod. After forging, the T-shaped or Y-shaped rod is bored along a main axis of the T-shape or the Y-shape so as to form a tubular portion suitable for receiving a portion of the telescopic shock absorber and so as to lighten the rod. The bore sometimes extends over more than one meter within the forged part, thereby lengthening production time. The forged and bored part is particularly expensive and complex to make. Making such a part relies on having forging means of large size. For example, a landing gear rod for an aircraft of the Airbus A320® type requires a forged part to be made that is about 1.50 meters long and about 1.20 meters wide. Such a part can be forged only with means that are uncommon and thus expensive.

### OBJECT OF THE INVENTION

An object of the present invention is thus to provide a landing gear rod at reduced cost.

### SUMMARY OF THE INVENTION

In order to achieve this object, the invention provides a landing gear rod for an aircraft, the rod comprising a tubular portion for receiving a shock absorber and an axle-carrier portion situated at the end of the tubular portion and adapted to receive a landing gear wheel support mechanism. This rod is essentially characterized in that the tubular portion and the axle-carrier portion are made of mutually distinct metal materials, the tubular portion being made of a first metal material and the axle-carrier portion being made of a second metal material, the tubular portion and the axle-carrier portion being connected together by at least one weld.

There are numerous advantages in making a landing gear rod by welding together a tubular portion, e.g. made by extrusion, and an axle-carrier portion made of another material such as a material that is forged or a material that is molded and subjected to hot isostatic pressing. In particular, there is no longer any need to bore the rod of the T-shape in order to form the tubular portion. Instead of forming a rod as a single piece, it is made up as a plurality of portions that are made separately from one another prior to being assembled together by welding. By means of the invention, the production means used for producing the rod, such as die-stamping means or isostatic hot press means can be smaller in size than would otherwise be needed if the rod were a single part.

In position, given the local mechanical stresses that need to be withstood by the rod, it is essential for the axle-carrier portion to be particularly strong. By means of the invention, there is no longer any need for the tubular portion of the rod to be made of a material that presents the same strength characteristics as the strong material of the axle-carrier portion. Thus, although in order to impart a high level of mechanical strength thereto the axle-carrier portion needs to be forged or made by hot isostatic pressing of a molded part, these forging or hot pressing operations can be limited to the minimum strictly required, i.e. to the sole portion of the rod that is to receive the wheel support mechanism, and need not concern the tubular portion. The tubular portion is thus not necessarily forged or hot pressed. Specifically, as explained below, the tubular portion is preferably produced by extrusion in order to orient its fibers so as to improve the bending strength of the rod of the invention. Consequently, this tubular portion may be produced with standard section member tubes that are merely cut to length.

In order to satisfy the above-mentioned objects, the invention also provides a method of fabricating a landing gear rod for an aircraft, wherein a welding operation is used to connect together:
a tubular portion adapted to receive a shock absorber of the landing gear; and
an axle-carrier portion adapted to receive a landing gear wheel support mechanism;

the tubular portion and the axle-carrier portion being made of respective first and second mutually distinct metal materials and the axle-carrier portion preferably being made by forging or by hot pressing a molded part.

The invention also provides landing gear as specified above and/or as made in accordance with the method of the invention.

Finally, the invention provides an aircraft characterized in that it includes at least one piece of landing gear of the invention.

The manufacture of the axle-carrier portion of a landing gear rod of the invention is performed by forging operations such as stamping or die-stamping and by a molding operation followed by hot pressing. Even though the tubular portion may also be made by forging, it is generally preferable for it to be made by extrusion.

To understand the present invention, extrusion should not be considered as being a forging operation, where forging consists in die-stamping, and/or stamping, and/or coining, and not extruding.

### BRIEF DESCRIPTION OF THE DRAWING

Other characteristics and advantages of the invention appear clearly from the following description made by way of non-limiting indication and with reference to the accompanying drawings, in which:

FIGS. 1a and 1b show the making of a Y-shaped landing gear rod in a first embodiment of the invention;

FIGS. 2a and 2b show the making of a T-shaped landing gear rod in an alternative second embodiment of the invention; and

FIGS. 3a and 3b show the making of a T-shaped landing gear rod of the invention in an embodiment that is an alternative to that of FIG. 2b (in FIGS. 1a, 1b, 2a, 2b, 3a, and 3b the rod and its parts are shown in longitudinal section on axis X-X. FIGS. 1a, 2a, and 3a show the parts forming the rod prior to assembly and FIGS. 1b, 2b, and 3b show the respective rods after they have been assembled).

### DETAILED DESCRIPTION OF THE INVENTION

As mentioned above, the invention consists essentially in a landing gear rod 1 for sliding at least in part in a landing gear strut (not shown in the figures).

The rod is made by welding an axle-carrier portion 2 made by forging or by molding with hot pressing to a tubular portion 3 or tube 3, preferably by using an annular weld 4.

The forging includes at least one die-stamping operation.

Pressing or hot pressing a molded part (also known as hot isostatic pressing (HIP)) consists in molding a metal part to have the required shape and in placing it in the enclosure of a furnace in which ambient pressure is several hundreds of bars, preferably lying in the range 1000 bars to 1500 bars, and where the temperature is high but without going beyond the melting temperature of the metal material forming the part. Under such conditions, any pores in the molded part disappear in part, thereby improving the mechanical characteristics of the molded part in a manner that is substantially equivalent to what the characteristics would have been if the part had been obtained by forging. Given the pressure and temperature conditions inside the enclosure of the furnace, this technique can be used only for parts of small dimensions. By means of the invention, the portion(s) that are not yet assembled with the rod, such as the axle-carrier portion 2a, 2d, are of dimensions that are compatible with the enclosures of hot press furnaces, thus making it possible to make landing gear rod portions using standard pressurized furnaces. It should be observed that it may be advantageous to mold a part rather than to forge it since molding makes it possible to obtain the required shapes directly, which shapes cannot be obtained directly by forging.

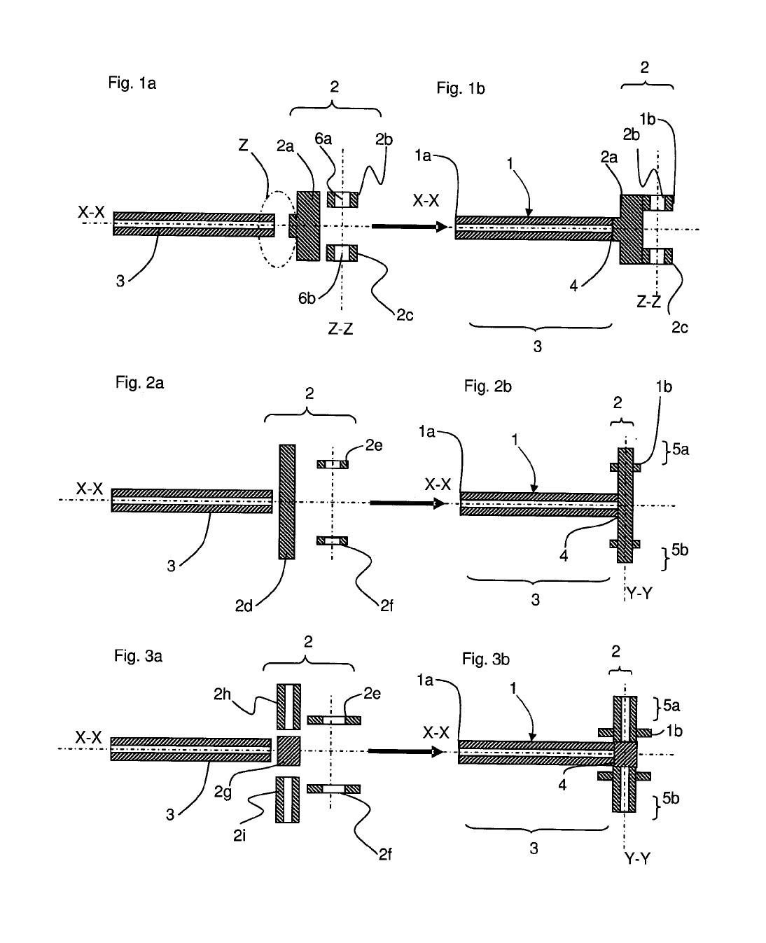

As shown in FIGS. 1b, 2b, and 3b, the landing gear rod 1 extends along a longitudinal axis X-X and has first and second end portions 1a and 1b that are spaced apart from each other.

The tubular portion 3 extends between the weld 4 and the first end 1a.

The axle-carrier portion 2 extends between the weld 4 and the second end 1b.

The landing gear includes a shock absorber (not shown in the figures) that is deigned to penetrate into the strut and bear against the landing gear rod 1, and to penetrate at least in part inside the tubular portion 3. It should be observed that under certain circumstances, the tubular portion 3 may act as the piston of a shock absorber, with the cylinder of the shock absorber then being constituted in the strut. The shock absorber serves to damp the sliding movements of the landing gear rod inside the landing gear strut.

The strut is designed to be assembled to the aircraft, and the axle-carrier portion 2 is designed to receive a landing gear wheel support mechanism. This landing gear wheel support mechanism is not shown in the figures, but it may be constituted:
either by rolling bearings mounted around the axle 2d of the landing gear rod, as for the T-shaped rod in FIGS. 2a and 2b, or the T-shaped rod in FIGS. 3a and 3b;
or else, with a Y-shaped rod as shown in FIGS. 1a and 1b, a truck (not shown in the figures) for carrying a plurality of wheels with the help of two or more off-axis axles.

The landing gear rod of FIGS. 1a and 1b (FIG. 1a shows the Y-shaped rod prior to welding, and FIG. 1b shows it after welding) is a Y-shaped rod designed to carry a truck having a truck rocker bar pivotally mounted relative to the axle-carrier portion of the Y-shaped rod. This truck (not shown in the figures) has a plurality of axles of axes that are spaced apart from one another in order to carry respectively at least a front pair of wheels and at least a rear pair of wheels.

In order to make a straight landing gear rod in accordance with the various embodiments of the invention and providing an interface between the strut, the shock absorber, and the landing gear wheel support mechanism, a tube 3 is used for constituting a shank, together with one or more parts 2a, 2b, 2c, 2d, 2e, 2f, 2g that have been forged or molded and then hot pressed. These parts 2a, 2b, 2c, 2d, 2e, 2f, 2g constitute the axle-carrier portion 2. These (forged/die-stamped or molded and hot pressed) parts have the feature of being short in length compared with the length of the tubular portion 3. Such die-stamped parts 2a, 2b, 2c, 2d, 2e, 2f, 2g of the axle-carrier portion 2 can be made using die-stamping or hot press means that are small in size compared with the die-stamping means that are needed for making a single piece landing gear rod of equivalent size, by die-stamping or molding and hot pressing.

As explained below, given that the rod is made by welding together a plurality of portions, the materials constituting it may be selected so as to obtain characteristics that are optimized for each zone of the rod 1.

Thus:
the first material for the tubular portion 3 is preferably selected from a group of materials comprising an aluminum alloy, and a titanium alloy; and
the second material for the forged axle-carrier portion 2 is preferably selected from a group of materials comprising steels, aluminum alloys, and titanium.

The first material of the tubular portion 3 is consequently selected for its ability to bend without breaking and/or for its light weight and/or for its ability to avoid buckling under the effect of the impact of landing, whereas the second material of the axle-carrier portion 2 is selected for its ability to withstand traction and/or compression and/or corrosion.

By way of example, if it is desired to obtain a lightweight landing gear rod having good resistance against corrosion, the first material should be an aluminum alloy that is light in weight, while the second material should be titanium alloy that is relatively insensitive to corrosion.

On this topic, it should be observed that the landing gear rod that is the most sensitive to corrosion is situated at the level of the axle-carrier portion 2 that is closest to the ground and consequently that is the most likely to receive projections of chemicals such as runway antifreeze or impacts from pieces present on the ground such as stones.

The invention also makes it possible to act on the orientation of the fibers of the rod.

Thus, since the tubular portion 3 is preferably made by extruding a first material along an extrusion axis, the fibers of the tubular portion 3 are oriented parallel to one another and to the longitudinal axis X-X. The tubular portion 3 as obtained in this way possesses greater capacity for bending while having a reduced risk of breaking on impact, compared with a forged part.

Furthermore, since the axle-carrier portion 2 is welded to the end of the tubular portion 3, the fibers of the tubular portion 3 are then oriented in the same direction relative to said forged axle-carrier portion 2. The work of designing a strong landing gear rod is thus made easier since the orientation of the fibers in the tubular portion 3 in the vicinity of its zone of contact with the axle-carrier part 2 is known exactly. This would not be true if the rod were made as a single die-stamped part, since the die-stamping would have the effect of deflecting at least the surface fibers of the rod.

In the invention, the respective shapes of the axle-carrier portion 2 and of the tubular portion 3 may be designed so that in the vicinity of the contact zone Z between the tubular portion 3 and the axle-carrier portion 2 and prior to welding, the majority of the fibers (both the fibers of the tubular portion 3 and the fibers of the axle-carrier portion 2 in the vicinity of the contact zone):
are tangential to lines in directions parallel to the longitudinal axis X-X of the tubular portion 3, as shown in FIG. 1a; or
are tangential to lines in directions perpendicular to the longitudinal axis X-X of the tubular portion 3, as shown in FIGS. 2a and 3a.

It should be observed that the first material forming the tubular portion 3 is generally extruded by pushing this material in the ductile state through a die so as to form simultaneously a hollow zone inside the first material while it is being extruded. The tubular portion 3 is produced merely by extrusion without there being any need to bore a forged part in order to form the tube. This saves an operation of boring a forged part which until now has been particularly expensive in terms of time and material.

In the Y-shaped embodiment of the rod as shown in FIGS. 1a and 1b, the axle-carrier portion 2 carries two projections 2a and 2b extending parallel to each other and parallel to the longitudinal axis X-X of the tubular portion 3.

These projections 2a and 2b, which are in the form of plates, are spaced apart from each other so that when they are assembled they form a Y-shaped fork, as shown in FIG. 1b.

Each projection 2a, 2b presents its own bore 6a, 6b extending along a transverse axis Z-Z perpendicular to the longitudinal axis X-X of the tubular portion 3.

As mentioned above, this Y-shaped fork enables a rocker bar of the landing gear wheel support mechanism, specifically a truck, to be mounted in a fork. This rocker bar passes between these projections 2b and 2c and pivots about a transverse pivot (not shown in the figures) that extends along the transverse axis Z-Z inside the bores 6a and 6b of the projections 2b and 2c.

The Y-shaped landing gear rod 1 is thus made up of:
an axle-carrier portion 2 in the form of a Y-shaped fork comprising at least one forged part 2a and preferably comprising three forged parts 2a, 2b, and 2c; and
a tubular portion 3 of metal welded to the forged part 2a of the axle-carrier portion 2.

It should be observed that in order to form the Y-shaped fork, it is possible, as in the example of FIG. 1a, to make use of:
a central portion 2a of the axle-carrier portion 2 that is welded to the tubular portion 3; and
two lateral portions 2b, 2c that are respectively welded to the central portion 2a so as to form the projections of the forged axle-carrier portion 2a.

These lateral portions 2b, 2c are preferably welded to the central portion 2a by friction welding.

As an alternative to this embodiment of FIG. 1a, the axle-carrier portion in the form of a Y-shaped fork may be formed by forging a single piece. For this purpose, a metal block is created by die-stamping that presents a zone that is to be welded to the tubular portion and two zones that are to form the projections 2b and 2c. Alternatively, the metal block may be made by molding followed by hot isostatic pressing, prior to being welded to the tubular portion.

It should also be observed that the friction weld 4 between the tubular portion 3 and the axle-carrier portion 2a is preferably made by establishing relative rotation between the axle-carrier portion 2a and the tubular portion 3. The parts 2b and 2c are welded to the part 2a after making the weld 4.

It should also be observed that friction welding the central portion 2a of the fork (FIG. 1b) with the respective lateral portions 2b and 2c could be performed by linear friction welding.

The advantage of friction welding is that it gives rise to diffusion of atoms at the interface between the welded-together parts, so the quality of the bond as obtained in this way is better than the quality of the welded materials themselves. There is no need to provide any filler metal, which means that it is possible to weld together materials that are different. The welds used for making the rod of the invention and for performing the method of the invention are preferably inertial, linear, or orbital friction welds making it possible to conserve the properties of the forged materials and the properties of the materials forming the tubular portion that is to receive the shock absorber.

By way of illustration, landing gear having a fork-shaped landing gear rod for mounting a rocker bar in the fork is described in patent document GB 2 474 686. In that document, the landing gear rod carries a wheel support mechanism that is a truck in which the rocker bar pivots on a transverse pivot passing through the bores in the projections. The rod of that prior art landing gear is a single piece and it could advantageously be replaced by the landing gear rod of FIG. 1b.

In the embodiment of the rod shown in FIGS. 2a and 2b (FIG. 2a shows the T-shaped rod before welding and FIG. 2b after welding), the axle-carrier portion 2 also possesses two lateral projections. However, in this embodiment, the projections form axles 5a, 5b both extending along an axle axis Y-Y. These axles 5a, 5b extend on either side of a longitudinal axis X-X of the tubular portion 3, and the axle axis Y-Y is perpendicular to the longitudinal axis X-X so that the landing gear rod 1 is T-shaped.

In the embodiment of FIGS. 2a and 2b, the axles 5a and 5b form integral portions of the forged axle-carrier portion 2 and they are thus forged projections of the axle-carrier portion. This provides structural continuity of material between the axles 5a and 5b and the axle-carrier portion 2. This limits any risk of breaking the connection between the axle-carrier portion 2 and the axles 5a and 5b, since they are the result of working a single block of metal in forging.

Ideally, and as can be seen in FIG. 2a, the axle-carrier portion 2 is made with a single forged shaft that may be solid or hollow. The central portion of this axle shaft 2d is preferably welded by linear friction welding to the tubular portion 3.

Two rings 2e and 2f are respectively welded concentrically around the shaft 2d of the axle-carrier portion 2. These rings 2e and 2f are arranged symmetrically on either side of the axis X-X and they form fastener rings for brake stators of the landing gear.

The brake rings or collars 2e, 2f are preferably welded by inertial friction welding on the axle-carrier bar. Holes are made through these rings for passing brake-fastener studs.

In an alternative embodiment, not shown in the figures, it is also possible for the axles to be formed by a transverse bar that is distinct from the axle-carrier portion 2, the transverse bar being for example engaged in a bore formed in the axle-carrier portion and extending along the axle axis perpendicularly to the longitudinal axis of the tubular portion.

Another embodiment of a T-shaped rod is shown in FIGS. 3a and 3b. In this embodiment, the rod comprises:
a central portion 2g of the axle-carrier portion 2 that is welded to the tubular portion 3;
two tubular lateral portions 2h, 2i respectively welded to the central portion 2a in such a manner as to form right and left axles 5a and 5b of the axle-carrier portion 2; and
two annular disks 2e and 2f similar to the disk of FIG. 2b (each disk 2e and 2f being welded to a respective one of the axles 2h and 2i of the rod; each of these disks 2e and 2f serves to fasten a corresponding brake).

The central portion 2g may be made by forging or molding and hot isostatic pressing. The axles 2h, 2i are tubes formed by extrusion or by molding and hot pressing or possibly by forging. These axles 2h, 2i are welded to the central portion 2g by orbital friction. This embodiment serves to reduce the size of the parts forging the rod since, unlike the embodiment of FIG. 2b, in this embodiment the axle-carrier portion 2 is short in length and is made up of two small axles welded to a central portion 2g. In this embodiment, it is possible to make the tubular portion 3 and the axles 2h and 2i with standard extruded or drawn tubular section members and the central portion 2g being one of the only parts made by forging or molding and pressing, since it is the portion of the rod 1 that is subjected to the highest stresses in use. With this embodiment, there is no need to make tubular axles 2h, 2i by boring forged parts.

1. A landing gear rod (1) for an aircraft, the rod comprising a tubular portion (3) for receiving a shock absorber and an axle-carrier portion (2) situated at the end of the tubular portion (3) and adapted to receive a landing gear wheel support mechanism, the rod being characterized in that the tubular portion (3) and the axle-carrier portion (2) are made of mutually distinct metal materials, the tubular portion (3) being made of a first metal material and the axle-carrier portion (2) being made of at least one second metal material, the tubular portion (3) and the axle-carrier portion (2) being connected together by at least one weld (4).

2. The landing gear rod according to claim 1, wherein said second material is a forged material or a material that has been molded and pressed by hot isostatic pressing.

3. The landing gear rod according to claim 1, wherein the axle-carrier portion (2) possesses two lateral projections (5a, 5b) forming axles that both extend along an axle axis (Y-Y), these axles (5a, 5b) extending on either side of a longitudinal axis (X-X) of the tubular portion (3), and the axle axis (Y-Y) being perpendicular to the longitudinal axis (X-X) of the tubular portion so that the landing gear rod (1) is T-shaped.

4. The landing gear rod (1) according to claim 1, wherein the axle-carrier portion (2) carries two projections (2b, 2c) extending parallel to each other and to a longitudinal axis (X-X) of the tubular portion (3), these projections (2b, 2c) being spaced apart from each other to form a fork and each presenting a bore (6a, 6b) extending along a transverse axis (Z-Z) perpendicular to the longitudinal axis (X-X) of the tubular portion (3).

5. The landing gear rod (1) according to claim 4, wherein the axle-carrier portion (2) is constituted by:
a central portion of the axle-carrier portion that is welded to the tubular portion (3); and
two lateral portions respectively welded to the central portion so as to form the projections (2b, 2c) of the axle-carrier portion (2).

6. The A landing gear rod according to claim 1, wherein the weld (4) is a friction weld connecting together the axle-carrier portion (2) and the tubular portion (3).

7. The landing gear rod according to claim 1, wherein the tubular portion (3) is an extruded portion.

8. The landing gear rod according to claim 1, wherein:
the first material of the tubular portion (3) is selected from a group of materials comprising at least an aluminum alloy and at least a titanium alloy; and
the second material of the axle-carrier portion (2) is selected from a group of materials comprising steels, and titanium alloys.

9. A landing gear including a landing gear rod (1) according to claim 1, and further including a telescopic shock absorber arranged at least in part inside the tubular portion of the rod, and wheels each carried by a respective one of the axles carried by the axle-carrier portion.

10. An aircraft, characterized in that it includes at least one piece of landing gear according to claim 9.

11. A method of fabricating a landing gear rod (1) for an aircraft, wherein a welding operation is used to connect together:
a tubular portion (3) adapted to receive a shock absorber of the landing gear; and
an axle-carrier portion (2) adapted to receive a landing gear wheel support mechanism;
the tubular portion (3) and the axle-carrier portion (2) being made of respective first and second mutually distinct metal materials, the axle-carrier portion (2) preferably being made by forging or by isostatic hot pressing a molded part.
